(19) United States
(12) Patent Application Publication
(10) Pub. No.: US 2017/0354984 A1
(43) Pub. Date: Dec. 14, 2017

(54) TOILET TISSUE MISTER

(71) Applicant: THOMAS W. BEAL, AKRON, OH (US)

(72) Inventor: THOMAS W. BEAL, AKRON, OH (US)

(21) Appl. No.: 15/618,198

(22) Filed: Jun. 9, 2017

Related U.S. Application Data
(60) Provisional application No. 62/347,739, filed on Jun. 9, 2016.

(51) Int. Cl. B05B 12/12; B05B 12/00; B05B 15/06; B05B 9/04; A47K 10/32

(52) U.S. Cl. CPC B05B 12/122; B05B 15/06; B05B 9/0403; B05B 12/002; A47K 10/32; A47K 2010/328

(57) ABSTRACT

A toilet tissue mister includes a cabinet with an open lower front section for receiving a user's hand bearing toilet tissue. A liquid-containing bottle is maintained within the cabinet above the open lower section. A spray head is positioned at a top portion of said open lower front section and a pump is interconnected between the bottle and the spray head. A control circuit is interconnected with an optical transducer switch maintained within said open lower front section and, upon sensing the presence of a user's hand, actuates the pump for a duration of time sufficient to coat the toilet tissue in the user's hand with a spray mist from the spray head.

### CROSS-REFERENCE TO RELATED APPLICATIONS

This application claims the priority of provisional U.S. Application Ser. No. 62/347,739 filed on Jun. 9, 2016 and whose contents are incorporated by reference.

### TECHNICAL FIELD

The invention herein resides in the art of devices for moistening toilet tissue. More particularly, the invention relates to devices for controlled or regulated moistening of toilet tissue. More specifically, the invention relates to devices for controlled or regulated moistening of toilet tissue through the emission of a spray burst of water alone or water in combination with scented and/or medicated additives.

### BACKGROUND OF THE INVENTION

Paper-based toilet tissue is typically used for personal cleansing after using the toilet for elimination of bodily waste. Such toilet tissue is typically dry and often “scratchy,” such that repetitive use can irritate the perianal area and cause discomfort. This is particularly true if hemorrhoids, sores, or the like already irritates the area. Moreover, the dry nature of toilet tissue fails to ensure the user that the perianal area has been fully cleaned of waste material.

It is important to most individuals that the perianal area feels clean, fresh and cool after the customary “wiping” following elimination. Presently, such cleansing can be achieved by using “wet wipes” or medicated wipes, but those items are typically costly and environmentally unfriendly, being of such a fibrous nature that they do not readily dissolve over time and are prone to clogging toilets as well as sewer and septic systems. Such problems are aggravated in high-usage areas such as hospitals, nursing homes and the like, where the use of “wet wipes” is extensive. In contradistinction, toilet tissue is readily dissolvable following extended exposure to water, while being very strong and maintaining structural integrity during even moistened usage.

It has been found that slightly moistened toilet tissue maintains its structural integrity and viability for typical wiping procedures, while assisting in cleaning, cooling and refreshing the perianal area of the user.

It has been previously known to mist or otherwise dampen toilet tissue and, indeed, toilet tissue misters have been used in the past. However, known toilet tissue misters have been prone to over-spraying, causing the spray to impinge upon adjacent walls, objects, and the floor. Known toilet tissue misters have not been of an adjustable or variable nature, but rather have been of a fixed nature, emitting a mist of fixed volume and character. Moreover, known misters have typically been cumbersome in use, lacking automated actuation, and often plumbed to the water system of the house or other facility, making installation and maintenance difficult, frustrating and often expensive.

There is a need in the art for a toilet tissue mister that prevents over-spraying against adjacent objects, walls and floors.

There is a further need for toilet tissue misters that are adjustable or variable as to the amount of water or solution emitted.

Moreover, there is a need for toilet tissue misters that are not cumbersome in use, but rather are given to single-handed use with associated automatic actuation.

Yet further, there is a need in the art for a toilet tissue mister that is self-contained, does not require interconnection to central plumbing, and is easily serviced.

### SUMMARY OF THE INVENTION

In light of the foregoing, it is a principle aspect of the invention to provide a toilet tissue mister that overcomes the deficiencies of the prior art by possessing and employing the desired features discussed directly above. These various aspects are achieved by a toilet tissue mister, comprising a cabinet having an open lower front section; a liquid-containing container within said cabinet above said open lower front section; a spray head positioned at a top portion of said open lower front section; a pump interposed between said container and said spray head; and a control circuit interposed between said open lower front section and said pump, said control circuit sensing a presence of a user's hand and activating said pump for a duration of time sufficient to coat toilet tissue in said user's hand with a spray mist.

### BRIEF DESCRIPTION OF THE DRAWINGS

For a complete understanding of the various aspects and features of the invention, reference should be made to the following detailed description and accompanying drawings wherein:

FIG. 1 is a perspective view of an embodiment of the toilet tissue mister assembly according to the present invention;

FIG. 2 is a side-elevational view of the assembly of FIG. 1 with a side removed to show the interior thereof;

FIG. 3 is a perspective view of an embodiment of the toilet tissue mister assembly according to the present invention;

FIG. 4 is a side-elevational view of an embodiment of the toilet tissue mister according to the present invention; and

FIG. 5 is a circuit schematic of the control circuitry of the toilet tissue mister assembly according to the present invention.

### DETAILED DESCRIPTION OF ILLUSTRATIVE EMBODIMENTS

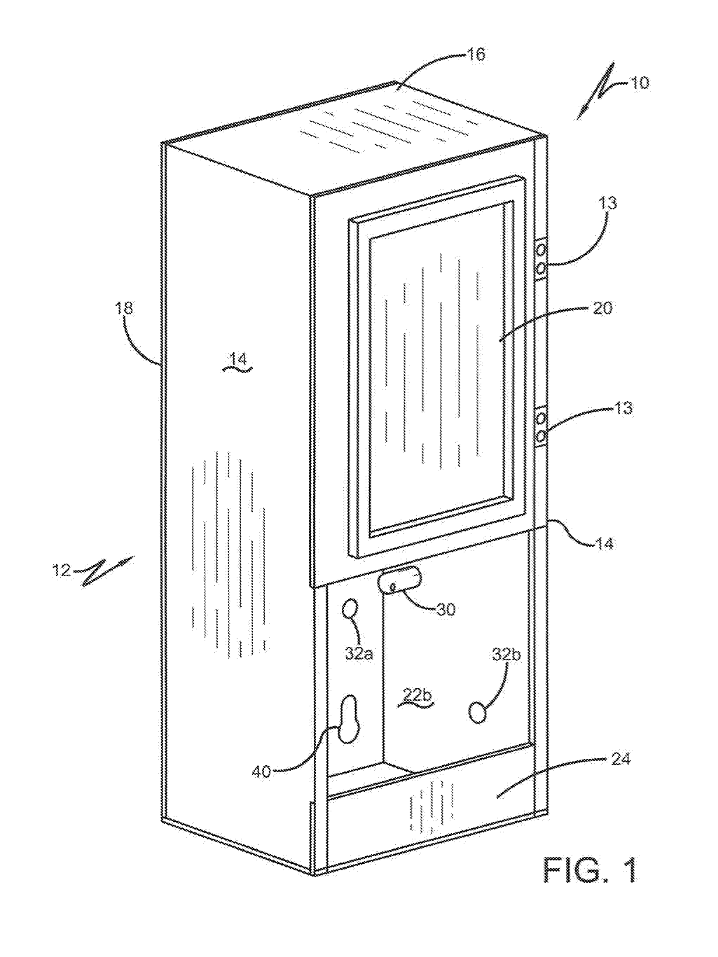

Referring now to the drawings, and more particularly FIGS. 1-4, it can be seen that a toilet tissue mister made in accordance with the invention is designated generally by the numeral 10. The mister 10 includes a cabinet 12 formed from a pair of opposed side panels 14 interconnected at opposite ends to top and bottom panels 16, all of which are interconnected by a back panel 18.

In one embodiment of the present invention, the cabinet 12 includes an upper cavity 22a and a lower cavity 22b. In one embodiment of the present invention, such as shown in FIG. 1, a door 20 selectively closes the upper cavity 22a of the cabinet 12, door 20 being connected to the cabinet 12 as by hinges 13, slides or the like to allow easy access to the upper cavity 22a. With the upper cavity 22a being selectively closed with door 20, the lower cavity 22b is always accessible and adapted for receiving a human hand bearing toilet tissue. In one embodiment of the present invention, the upper cavity 22a is separated from the lower cavity 22b by a dividing means 23. In one embodiment of the present invention, said dividing means 23 is in the form of a dividing panel containing an aperture. A base lip 24 is interconnected between bottom panel 16 and side panels 14, sealing the bottom-most portion of the lower cavity 22b such that runoff water, spray or mist may be accumulated therein.

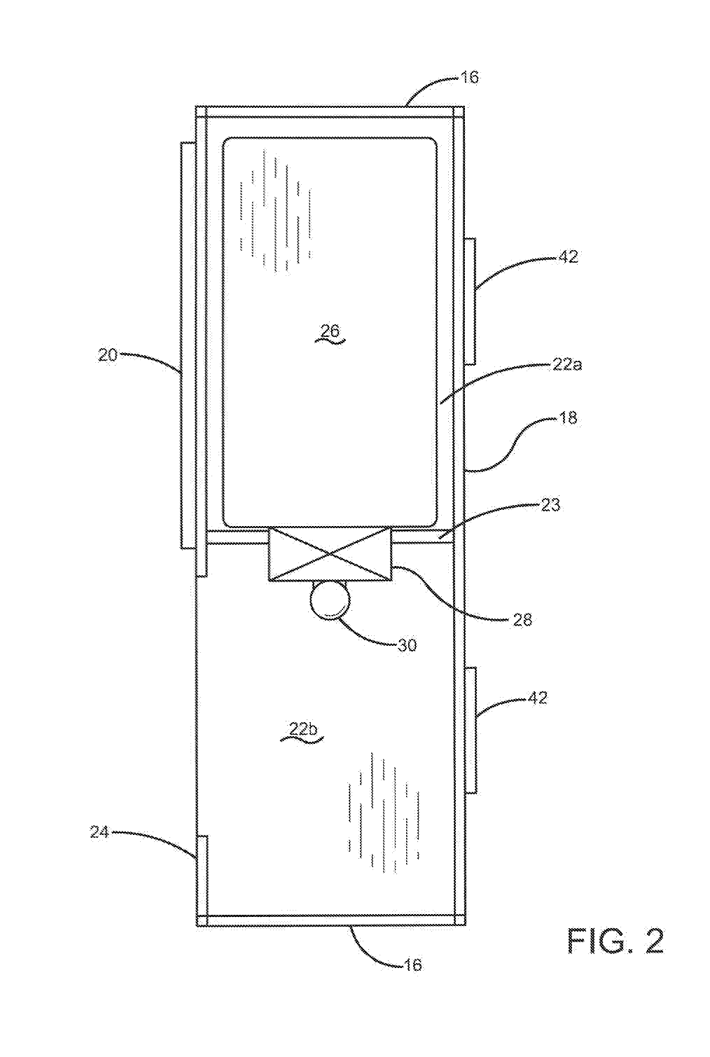

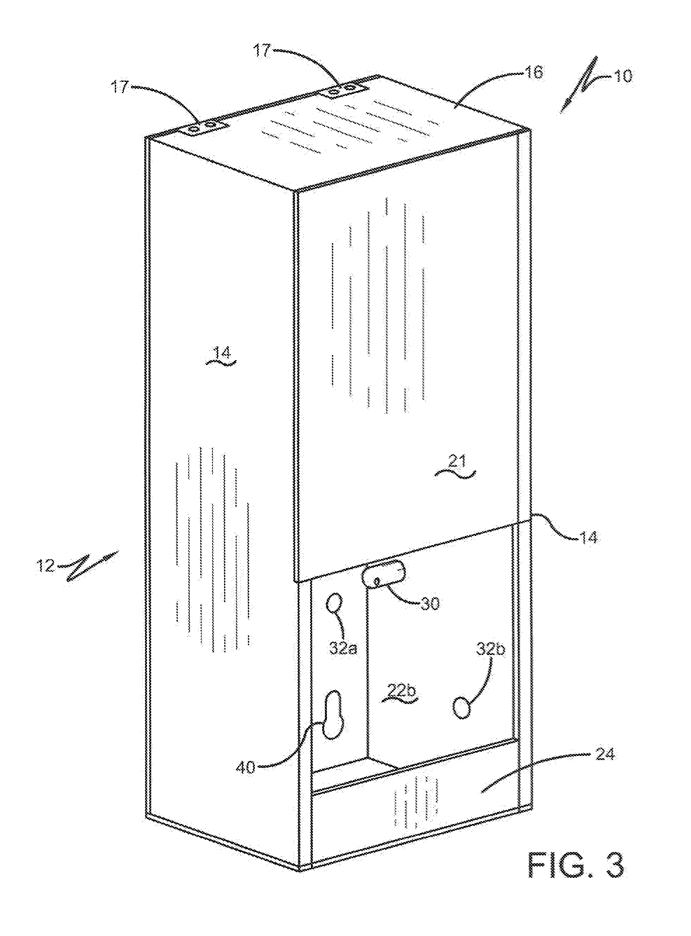

As shown in FIG. 2, a liquid container 26 is maintained within the upper cavity 22a and behind the door 20. The container 26 is placed within the upper cavity 22a such that the container 26 is placed on top of the dividing means 23. The container 26 is preferably removable and replaceable, such that it can be refilled with a liquid such as water, water in combination with scented and/or medicated additives, or other appropriate solutions when depleted. In one embodiment, the liquid container 26 is a bottle. In another embodiment, the liquid container 26 is in the form of a collapsible bag. In one embodiment of the invention, such as shown in FIG. 3, door 20 is replaced with a solid front panel 21 and instead, top panel 16 is connected to the cabinet 12 as by hinges 17, slides or the like, allowing easy access to the top of the liquid container 26 such that water or solution may be replenished in the container 26 without its removal. In another embodiment of the present invention (not shown), the door 20 is replaced with a solid front panel 21 and instead, the top panel 16 contains a removable cap which can be removed so as to allow access to the top of the liquid container 26 such that water or solution may be replenished in the container 26 without its removal.

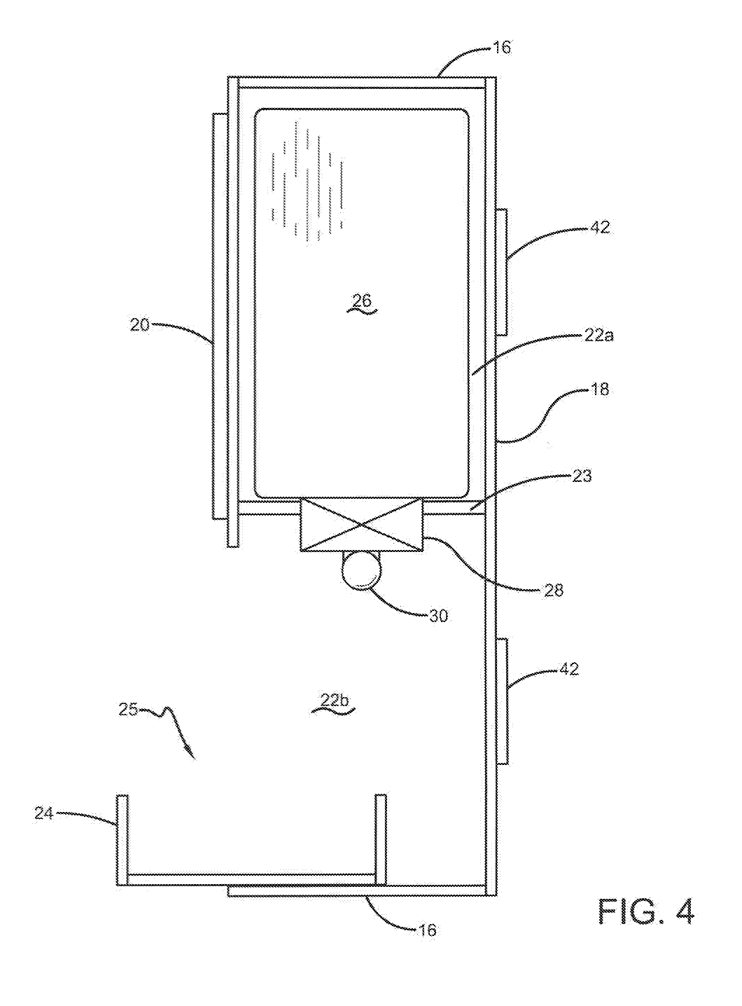

In one embodiment of the present invention, such as shown in FIG. 4, it is contemplated that the base lip 24 comprises a front wall portion of a removable tray 25 that sits above bottom panel 16 and that can be removed from the lower cavity 22b such that any runoff, water, spray or mist that may be accumulated in the removable tray 25 can be easily discarded by simply pulling out the removable tray 25 and discarding any contents therein.

Interconnected with the liquid container 26 is a pump 28 of any suitable type, such as a positive displacement pump. In a preferred embodiment, the pump 28 is controlled to emit a pressurized output of the liquid from the container 26 of a set volume on each stroke of the pump. In one embodiment, the pump 28 is a one-shot pump, which may have a fixed volume or an adjustable volume, allowing the user to adjust the amount of moisture emitted upon activation. Alternative to a one-shot pump would be a pump with a reciprocating piston that operates for a set or adjustable duration of time, emitting liquid from the container 26 on each stroke.

The pump 28 forces pressurized liquid to an atomizing spray nozzle 30, shown in FIGS. 1-4, which comprises the mister head. In one embodiment of the present invention, the pump 28 and spray nozzle 30 are situated so as to lie within the aperture of the dividing means 23 such that pump 28 and spray nozzle 30 are located within lower cavity 22b. The spray pattern of the mister head is preferably such that its fan width covers substantially the cross-sectional area of the lower cavity 22b in an area on the order of between about 0.3-1.00 of the distance between the spray nozzle 30 and the bottom of lower cavity 22b, in other embodiments from about 0.4-0.85 of the distance between the spray nozzle 30 and the bottom of lower cavity 22b, and in yet other embodiments from about 0.5-0.75 of the distance between the spray nozzle 30 and the bottom of lower cavity 22b. Since this is the general region in which a hand carrying toilet tissue would normally be inserted, this spray head configuration ensures optimum wetting of the toilet tissue.

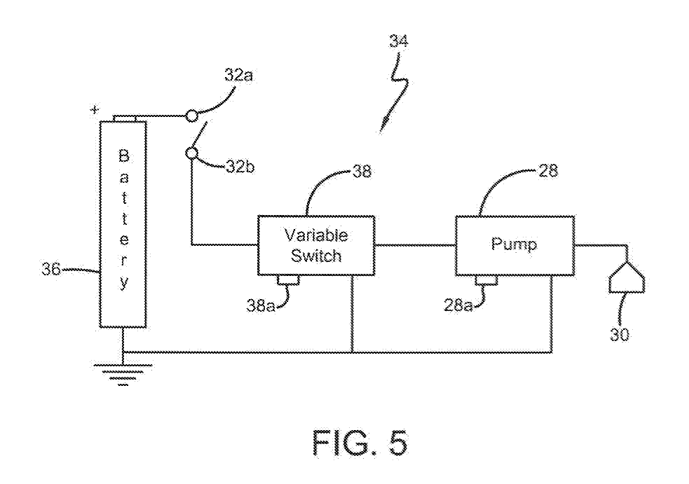

As shown in FIG. 1, there is also contained in the lower cavity 22b an optical transducer switch comprising a sender or transmitter 32a and a receiver 32b. Those skilled in the art will appreciate that the insertion of a hand carrying toilet tissue will break the path between the sender 32a and receiver 32b, causing the optical transducer switch to effectively close, actuating the mister through the control circuit 34 as shown in FIG. 5, which is preferably maintained in a portion of the upper cavity 22a, appropriately sealed or shielded from moisture or dampness. Here, a low-voltage battery 36 is interconnected with optical transducer switch 32 to the variable switch 38 which, in one embodiment of the present invention, is a momentary switch or a “one-shot” switch of selectable closure period. The period of time is sufficient to cause actuation of the pump 28 to affect a desired volume output of liquid to spray nozzle 30. The output of the variable switch 38 may be varied by means of an adjustment knob 38a, which might typically be a rheostat or variable resistor of a resistor-capacitor circuit to vary and control the width of the output pulse from the switch 38. The adjustment knob 38a allows for an ultimate increase or decrease in the volume of water or solution sprayed from the head 30.

As further shown, the pump 28 may also include an adjustment knob 28a that might be employed to control the output volume of the pump. It would typically not be necessary for both the switch 38 and pump 28 to be variable. In one embodiment, the switch 38 may simply actuate the pump 28, the volume of the output thereof being selectively adjustable by means of the adjustment knob 28a by controlling the stroke of the associated piston.

As shown in FIG. 1, mounting holes 40 (one being concealed by the door 20 or solid front panel 21) are positioned in the back panel 18 for receipt of screws or the like for ease of mounting to a wall surface. Alternatively, and as shown in FIG. 2, a double-backed tape 42 may be employed for this purpose. In a further embodiment, yet not shown in the drawings, the mounting holes 40 may be placed inside flanges or the like of the cabinet 12.

It is contemplated that in one embodiment of the present invention the height of the cabinet 12 would be between about 8 and about 20 inches, in another embodiment from between about 10 and about 18 inches, and in yet another embodiment between about 12 and about 16 inches. In one embodiment of the present invention, the height of the cabinet 12 is on the order of 14 inches. It is contemplated that in one embodiment of the present invention the width of the cabinet 12 would be between about 2 and about 12 inches, in another embodiment between about 4 and about 9 inches, and in yet another embodiment between about 5 and about 7 inches. In one embodiment of the present invention, the width of the cabinet 12 is on the order of 6 inches. It is contemplated that in one embodiment of the present invention the depth of the cabinet 12 would be between about 2 and about 6 inches, in another embodiment between about 3 and about 5.5 inches, and in yet another embodiment between about 4 and about 5 inches. In one embodiment of the present invention, the depth of the cabinet 12 is on the order of 4.5 inches.

It is contemplated that in one embodiment of the present invention, the height of either the door 20 or the front panel 21 would be between about 5 and about 12 inches, in another embodiment between about 6 and about 10 inches, and in yet another embodiment between about 7 and about 9 inches. In one embodiment of the present invention the height of either the door 20 or the front panel 21 would be on the order of 8 inches. It is contemplated that in one embodiment of the present invention, the height of the open portion of the lower cavity 22b would be between about 3 and about 8 inches, in another embodiment between about 3.5 and about 7 inches, and in yet another embodiment between about 4 and about 6 inches. In one embodiment of the present invention, the height of the lower portion of the lower cavity 22b would be on the order of about 5 inches. It is contemplated that in one embodiment of the present invention, the width of the open portion of the lower cavity 22b would be between about 3 and about 9 inches, in another embodiment between about 4 and about 8 inches, and in yet another embodiment between about 5 and about 7 inches. In one embodiment of the present invention, the width of the lower portion of the lower cavity 22b would be on the order of about 6 inches. It is contemplated that in one embodiment of the present invention, the height of the base lip 24 would be between about 0.25 and about 2 inches, in another embodiment between about 0.50 and about 1.75 inches, and in yet another embodiment between about 0.75 and about 1.25 inches. In one embodiment of the present invention, the height of the base lip 24 would be on the order of about 1 inch.

The dimensions just given can vary as to the desires of the user, but it is contemplated that a variation of plus or minus 20% and anywhere in between could be employed for a satisfactory unit, taking into account the typical size of a hand, the width of standard toilet tissue, the necessary volume for the liquid container 26, and the like. The lower cavity 22b is appropriately sized to receive the user's hand and toilet tissue therein such that the toilet tissue receives maximum exposure to the spray or mist from the spray nozzle 30, while the side panels 14 prevent over-spray onto adjacent objects or surfaces.

Thus it can be seen that the device presented and described above has achieved the various aspects of the invention. While in accordance with the patent statutes, only the best-known and preferred embodiment of the invention has been presented and described in detail, it will be appreciated that the invention extends beyond the particular embodiment presented for illustrative purposes herein.

What is claimed is:

1. A toilet tissue mister to supply a mist of a liquid to toilet tissue in a hand of a user of the mister, the mister comprising:
a cabinet having an upper cavity and a lower cavity;
a liquid-containing container within said upper cavity of said cabinet;
a spray head positioned at a top portion of said lower cavity;
a pump interposed between said container and said spray head; and
a control circuit interposed between said lower cavity and said pump, said control circuit sensing a presence of a user's hand and activating said pump for a duration of time sufficient to coat toilet tissue in said user's hand with a spray mist.

2. The toilet tissue mister of claim 1 wherein said cabinet is defined by a pair of opposed side panels interconnected at opposite ends to a top panel and a bottom panel; and wherein said opposed side panels, said top panel and said bottom panel are interconnected by a back panel.

3. The toilet tissue mister of claim 2 wherein the cabinet further includes a door to selectively close the upper cavity of the cabinet while allowing access to the liquid-containing container when the door is open such that the liquid within the container may be replenished without removal of the container from the cabinet.

4. The toilet tissue mister of claim 2 wherein the cabinet further includes a solid front panel to close the upper cavity of the cabinet.

5. The toilet tissue mister of claim 4 wherein the top panel of the cabinet is hinged, allowing access to a top of the liquid-containing container such that the liquid within the container may be replenished without its removal from the cabinet.

6. The toilet tissue mister of claim 4 wherein the top panel of the cabinet contains a removable cap which can be removed so as to allow access to a top of the liquid-container container such that the liquid within the container may be replenished without removal of the container from the cabinet.

7. The toilet tissue mister of claim 1 wherein said upper cavity and said lower cavity are separated by a dividing means.

8. The toilet tissue mister of claim 7 wherein the dividing means is a dividing panel containing an aperture such that the spray head sits within the aperture and is therefore located within the lower cavity of the cabinet.

9. The toilet tissue mister of claim 1 wherein said liquid-containing container is selected from a bottle and a collapsible bag.

10. The toilet tissue mister of claim 1 wherein said liquid-containing container is filled with a liquid selected from the group consisting of water or water in combination with scented or medicated additives.

11. The toilet tissue mister of clam 1 wherein said pump is a positive displacement pump.

12. The toilet tissue mister of claim 2 further comprises a base lip interconnected between the bottom panel and the pair of opposed side panels, such that the base lip seals a bottom-most portion of the lower cavity.

13. The toilet tissue mister of claim 12 wherein the base lip comprises a front wall portion of a removable tray, wherein said removable tray sits above the bottom panel.

14. The toilet tissue mister of claim 1 wherein a height of the cabinet is between about 8 and about 20 inches, a width of the cabinet is between about 2 and about 12 inches, and a depth of the cabinet is between about 2 and about 6 inches.

15. The toilet tissue mister of claim 1 wherein an output of the pump is made variable by means of an adjustment knob.

16. The toilet tissue mister of claim 1 wherein the control circuit includes an optical transducer switch, a variable switch and a power source.

17. The toilet tissue mister of claim 16 wherein the optical transducer switch comprises a sender and receiver, wherein both the sender and the receiver are located within the lower cavity of the cabinet.

18. The toilet tissue mister of claim 16 wherein the variable switch is a momentary switch having a selectable closure period.

19. The toilet tissue mister of claim 16 wherein an output of the variable switch is made variable by means of an adjustment knob.

20. A method of misting toilet tissue comprising the steps of:
a. collecting toilet tissue;
b. placing the collected toilet tissue within a toilet tissue mister wherein the toilet tissue mister comprises:
a cabinet having an upper cavity and a lower cavity;
a liquid-containing container within said upper cavity of said cabinet;
a spray head positioned at a top portion of said lower cavity;
a pump interposed between said container and said spray head; and
a control circuit interposed between said lower cavity and said pump, said control circuit sensing a presence of a user's hand and activating said pump for a duration of time sufficient to coat toilet tissue in said user's hand with a spray mist;
c. supplying a mist of liquid to the collected toilet tissue from the toilet tissue mister for said duration of time; and
d. removing the toilet tissue from the toilet tissue mister.
